(19) United States
(12) Patent Application Publication
(10) Pub. No.: US 2018/0356899 A1
(43) Pub. Date: Dec. 13, 2018

(54) ABISSINIA FORALL

(71) Applicant: Tewabtch Belete, San Francisco, CA (US)

(72) Inventor: Tewabtch Belete, San Francisco, CA (US)

(21) Appl. No.: 15/621,462

(22) Filed: Jun. 13, 2017

(51) Int. Cl. G06F 3/023

(52) U.S. Cl. CPC G06F 3/0233

(57) ABSTRACT

Aspects of the present invention include a method or process that allows both multi-lingual and unilingual alphabet users to equally utilize and write semitic or other unique alphabet on a computer or a device that attaches a keyboard. The method or process will create a designated key on a keyboard to write an alphabet by connecting or defining one or least possible unicode to reflect the alphabet. The invention, without departing from the main goal of simplifying use of unique alphabets for already familiar users, allows equal utilization for all types of users through exclusion of connection based on Latin or English alphabet pronunciation.

### CROSS REFERENCE TO RELATED APPLICATIONS

The present application claims the benefit of U.S. Provisional Patent Application 62/351,213 filed on Jun. 16, 2016.

### FIELD OF THE INVENTION

The invention relates to expression of unique scripts and/or alphabets for all types of users; it particularly relates to the expression of Ethiopian alphabets or Amharic Fidel, on a computer or device that connects keyboard, while it ensures that all types of familiar users of the Ethiopian Alphabets or Amharic Fidel can utilize the method or process of expression equally.

### BACKGROUND OF THE INVENTION

The Ethiopian alphabets or Fidel has existed for a long time, such that one might encounters it while studying archeology or the Bible. Though the Ethiopian alphabets/characters have existed for a tong time and evolved over time, it is still currently being utilized by millions of people and it is the national working language of Ethiopia. Of particular interest to our invention are methods or schemes using the Ethiopic unicode to reflect Geez, Fidel or Ethiopian alphabets on a computer like U.S. patent Ser. No. 12/271,650 (The Ethiopic character entry,) and AmharicTyping (http://www.amharicdictionayv.com/). The Ethiopic character entry's (U.S. patent Ser. No. 12/271,650) objective is to specify all the Geez or Ethiopian character using the standard QWERTY keyboard and map characters that can't be viewed using phonetic.

Even if the Ethiopic character entry, U.S. patent Ser. No. 12/271,650, and the other scheme grasp our attention there is one thing all of the methods and process have in common; the users need to be familiar with the Ethiopian characters, as well as, the English and/or Latin characters. Existing methods and processes utilize phonetic of English or Latin characters or letters combination to produce the Geez, Fidel or Ethiopian alphabets for significant amount of the characters. As such, currently all the methods or processes of expressing the Ethiopian alphabets or characters on a computer, including U.S. patent Ser. No. 12/271,650, requires that a user is fluent or has an average understanding of English or Latin prior to properly and effectively utilizing existing methods. Moreover, U.S. patent Ser. No. 12/271,650 utilizes a time elapse to determine what Geez or Ethiopian character is being requested, based on speed of key or combination of keys being punched on a keyboard. As there are significant amount of Fidel or Geez or Ethiopian characters that utilize the phonetic of English or Latin characters along with time elapse, it is clear to state that the methods or processes mentioned above are mainly suited for those who are fluent or have an average understanding of English or Latin phonetic. This Invention, Abissinia for All, is a method or process that allows equal utilization for all types of users, through exclusion of connection based on English or Latin alphabets pronunciation, without departing from the main goal of further simplifying use of Geez or Ethiopian characters on a computer. As you read further, it will be obvious that this invention is different from methods that reflect or produce Geez or Amharic characters on a computer known to the art.

### SUMMARY OF INVENTION

This invention is a method or process for writing Geez or Amharic alphabets or characters in a much more simplified way, while eliminating the requirement of knowing Latin, English or any other language's alphabet phonetic. This method or process allows both Ethiopian or Geez alphabets users who are unilingual and multilingual writers to utilize and display the Ethiopian or Geez alphabets on a computer screen or a device that connects a keyboard.

In accordance with the present invention, the method or process omits time elapse requirement limitations to reflect the Ethiopian or Geez alphabets and sustains utilization of the method to be relatively equal for all types of users without departing from the main idea of simplicity and efficiency for all users. The invention sets forth a designated location on a keyboard for the initial or main branches of the Ethiopian or Geez characters based on expected use frequency and for all sub-alphabets are assigned a designated location on the keyboard. As such, it makes it easier for the Ethiopian and Geez character users to easily and comfortably type all the characters one wishes without having to re-learn things, worry about speed, and/or the need to know the phonetic or pronunciation of the Ethiopian or Geez characters in Latin or English.

### BRIEF DESCRIPTIONS OF THE FIGURES

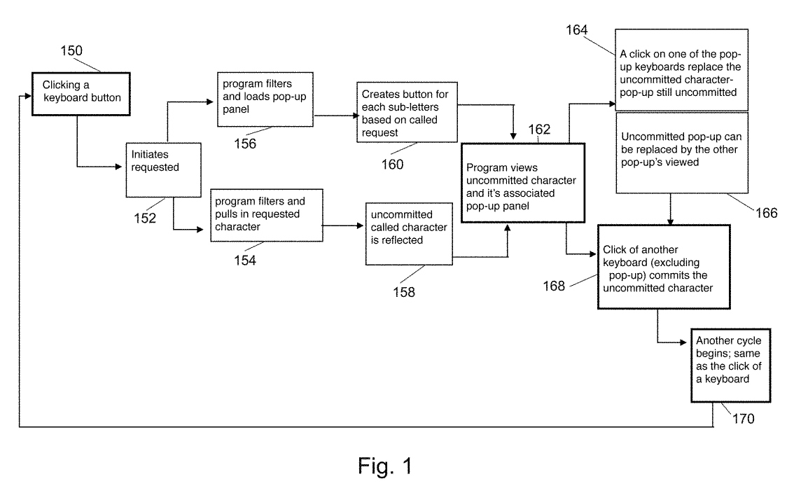

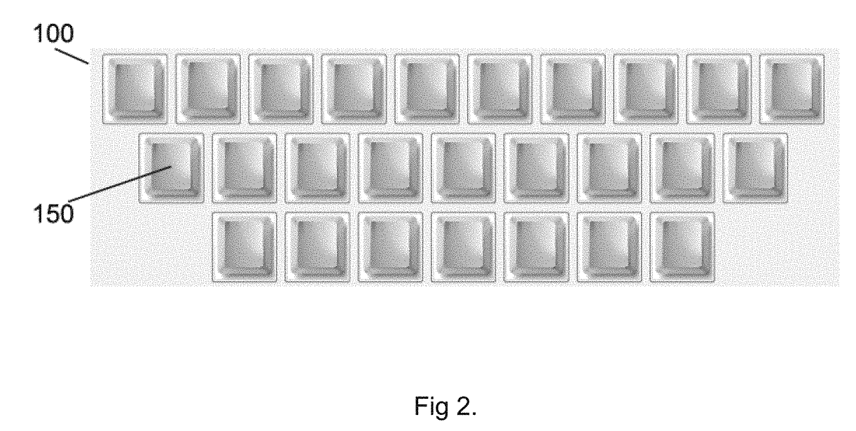

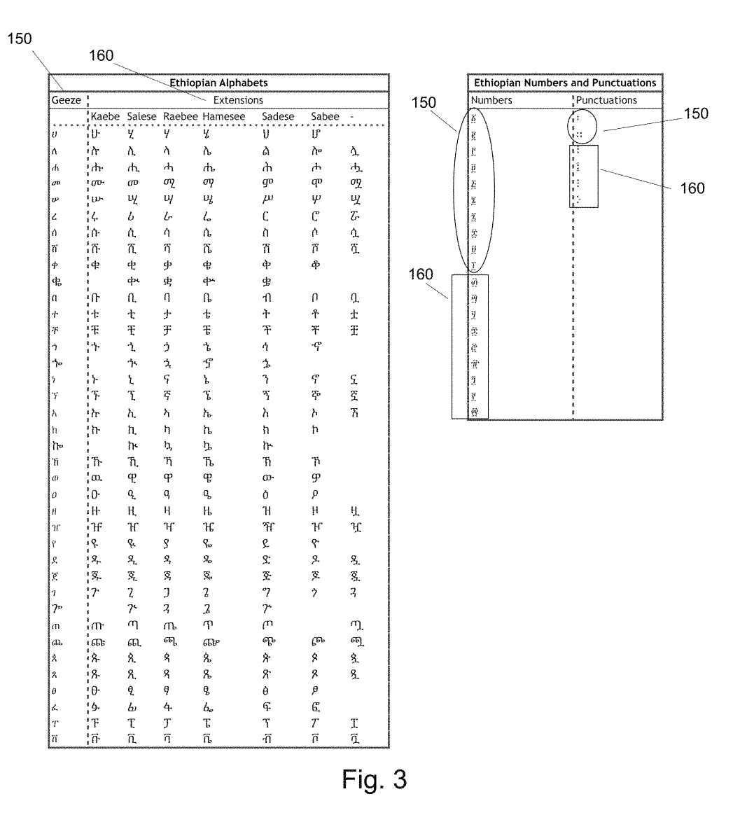

The invention is fully valued in connection with the following detailed description taken into conjunction with the accompanying images (FIG. 1, FIG. 2 & FIG. 3), in which it:

Illustrates the programing implementation process or method of inputting all the Ethiopian or Geez alphabets/characters, while avoiding the need to know Latin, English or any other languages pronunciation of the Ethiopian alphabets.
Illustrates the programming processes or connection methods with a keyboard's embodiment of a computer or a device that attaches a keyboard.
Illustrates the Ethiopian or Geez alphabets/characters the software will output, through the process or method of creating equal utilization by all type of users.
Refer to reference numerical of corresponding parts throughout the view of the figures drawings.

### DETAILED DESCRIPTION OF THE INVENTION

FIG. 1 illustrates a computer or device key 150 on a keyboard 100 (FIG. 2) implementing the invention. When a keyboard's alphabet section key is clicked 150, the click initiates a request 152 which sends for filter of request. Based on the initiated request 152, the program processes a filter to identify the request and takes two actions. First action is filtering to identifying the character requested 154, based on the clicked keyboard 150. While the first action filters and identifies the character request 154, the second action starts filtering through extensions for the specific request initiated 156. The second action filters through extension with the goal of locating extensions of the clicked key 150 character.

When the initiated request 150 is selected/clicked for a specific Ethiopian or Geez alphabet identified by the program 154 and is being viewed on the screen, the identified request is uncommitted 158 up until the user confirms request through a new initial request cycle 170. As the program process identifies the request for the clicked key's 150 character 154 and views it as uncommitted 158, the program simultaneously filters through extensions and loads a pop-up panel 156, on the computer screen, of the extensions for the requested character 150. Seeing a pop-up panel 156 with the extensions of the requested character indicated that a link has been created to keyboard/hardware for each of the extensions 160. At this point, the process or method has performed two actions 162: action 1—the un-committed requested character is reflected on the screen 158, and action 2—the extensions of the uncommitted characters ready for use 160. The path from the uncommitted stage could be to commit the reflected character on screen or to change the character to it's extension/sub-letter reflected on the pop-up panel 156.

If the request was initiated with the intent of reflecting extensions/sub-alphabets 160 of the requested character 158, clicking on the intended extension's key 164 will replace the uncommitted character 158. For this embodiment, the designated keys for extensions 160 are the function keys F1-F8 on the keyboard. When there is an initiated request, clicking on a function key 164 will result in change of character to one of its extensions. If request is intended for the character reflected on-screen 154 then clicking on another key on a keyboard 150 interrupts and commits 168 the uncommitted character 158. Clicking on another key on a keyboard will re-initiate another new request, starting the whole request cycle for another character 170.

As the extension/sub-alphabet 160 is linked to a keyboard's key through a prior request 150, clicking/selecting an extension's/sub-alphabet's linked key 164 on a keyboard is not considered as a full initial request. Clicking on sub-alphabet's key is a partial request 164, since clicking on a linked extension/sub-alphabet key 164 replaces the reflected character 158 with the extension or sub-alphabet 166. Similar to the full initial request, a partial request is going to be considered committed when the program is interrupted through a new initial request cycle 170.

FIG. 2 illustrates the exterior of a computer or devices keyboard 100; that reflects the 26 english alphabets. These 26 keys 150 on a keyboard, under this invention, are replaced by the frequently used Ethiopian or Geez (Geeze) root alphabets. As the Geez (Geeze) or Ethiopian root alphabets/characters are more than 26 letters, the method/process of this invention has retained the caps key/section of default keyboards for the remaining Geez (Geeze) root alphabets. Similar to the remaining Geez root alphabets, the frequently used punctuations and numbers 1-20 are also reflected on the remaining portion of the caps key/section of the keyboard 100.

FIG. 3 illustrates the Ethiopian or Geez alphabets, numbers, and punctuations the program's method will integrate and process to allow equal utilization by all types of users. The Ethiopian or Geez alphabet is one of the oldest dialects that exist in the world. When the Ethiopian or Geez language was created, it started with main/root characters called Geez (Geeze) 150 that are less than forty. Though the Ethiopian alphabets/characters are also referred to as Geez alphabets, this initial name Geez (Geeze) 150 was given to the root/main alphabets that were the first branch of the Ethiopian alphabet/Characters. Over time as Geez (Geeze) 150 alphabets expanded, it lead to including what we now refer as the Geez (Geeze) 150 alphabet extensions/sub-alphabets 160. As illustrated on FIG. 3, these extensions 160 are called Kaebe, Salese, Raebee, Hamesee, Sadese, Sabee, and one more extension that doesn't have a name. Most of the Geez (Geeze) 150 alphabets now have six extensions. The method or process of this invention takes the initial root alphabets Geez (Geeze) 150, and expresses it as default keyboard; similar to how the English alphabets are reflected on a computer or devices that connects a keyboard. When a default Geez (Geeze) 150 alphabet request is initiated and reflected 158 (FIG. 1), the extensions 160 (FIG. 1) of the requested alphabet's/character's 154 (FIG. 1) are reflected on the computer screen as pop-up panel 156 (FIG. 1) and linked to keys on the keyboard 160. The Geez (Geeze) 150 root alphabets/characters that are frequently used are reflected on the default 26 keyboard keys and the remaining Geez (Geeze) 150 root alphabets/characters that couldn't be reflected due to 26 alphabet/character key shortage are reflected on the caps/capital section of the keyboard; Geez (Geeze) 150 root alphabets/characters location being on the default or caps section was determined based frequency of use of each root character. Once all the Geez (Geeze) 150 root alphabets/characters have been assigned on the keyboard's default or caps/capital section, two or three of the Ethiopian punctuations and numbers 1 through 10 and one more number will be reflected (FIG. 3—Ethiopian Number's and Punctuations) on the remaining caps/capital section of the keyboard. Similar to the Geez (Geeze) 150 root alphabets' extensions, the remaining numbers or punctuations 160 (FIG. 3—Ethiopian Number's and Punctuations) are linked as extensions to one of the numbers and the punctuations keys on the caps/capital section of the keyboard and rejected as pop-up panel 156 (FIG. 1).

For all the extensions of the Geez (Geeze) 150 alphabets/characters or punctuation or number characters the designated keys are the function keys on the keyboard, F1 through F8. For example: if you click on the first Geez (Geeze) 150 alphabet's key “ [symbol] ” (FIG. 3) on the keyboard, it's extensions “ [symbol] , [symbol] , [symbol] , [symbol] , [symbol] , & [symbol] ” (to the right of the main/root Geez alphabet—FIG. 3) pop-up as panel and will be reflected on the computer screen. Similarly, whichever Geez (Geeze 150) character is selected all it's extensions (160) to its right will pop-up and be linked to function keys based on the number of extension. For example since “ [symbol] ” has six extension, the keys for the extensions the function keys that will be linked are F1 through F6; clicking on F2 will result in “ [symbol] ” and clicking on F6 “ [symbol] ”. The number of function keys linked as extension will increase or decrease from F1 to F8 based on the Geez (Geeze) 150 character/alphabet; if a Geez (Geeze) 150 has 4 extension, the function keys that will be linked will be from F1-F4.

The forgoing embodiment relies upon the placement of the Ethiopian alphabets/characters within a program in a way that makes it simple, for a person who is unilingual and uses only the Ethiopian alphabets/characters. As such, allowing unilingual Ethiopian alphabets/characters user to effectively and equally utilize a computer keyboard and/or a devices that connects a keyboard to communicate his/her thoughts just like any other bilingual person.

The method or process of the program creates a default keyboard location for each of the Geez (Geeze) 150 Ethiopian alphabets/characters and allows a click of a Geez (Geeze) 150 alphabet/character to produce extensions 160 to be linked to designated function keys that the user will automatically recognize without the need to know English/Latin or any other language. By doing the prior, this embodiment creates a way to completely eliminate the need for time elapse by coming up with another way of placing a location for the two hundred fifty plus extensions.

The descriptions above are means of illustration not means of limitations. Although the interactions of program method or process, placement, and designs mentioned above are recommended for the use of the Ethiopian unique alphabets, obviously many modifications, implementation to other unique alphabets of other regions and variances to programing, placements, and designs are feasible without departing from the spirit and scope of the invention. It is intended that the following claims and their equivalents define the scope of the invention.

1. A computer implemented method of displaying Ethiopian alphabet characters comprising:
displaying a root Ethiopian alphabet character at a cursor location on a computer screen in response to a user clicking a keyboard button;
displaying a popup panel on the computer screen in response to the user clicking the keyboard button, the popup panel displaying Ethiopian alphabet extensions of the root Ethiopian alphabet character and designated keyboard buttons for selecting from among the Ethiopian alphabet extensions; and
replacing the root Ethiopian alphabet character with a particular Ethiopian alphabet extension at the cursor location in response to the user clicking a particular designated keyboard button from among the designated keyboard buttons.

2. The computer implemented method of claim 1 further comprising:
displaying a second root Ethiopian alphabet character at a next cursor location in response to the user clicking a non-designated keyboard button; and
displaying the popup panel on the computer screen in response to the user clicking the non-designated keyboard button, the popup panel displaying extensions of the second root Ethiopian alphabet character and the designated keyboard buttons for selecting from among the extensions.

3. The computer implemented method of claim 1 wherein the keyboard comprises an external keyboard.

4. The computer implemented method of claim 1 wherein the designated keyboard buttons comprise function keys like F1-F8 or z-m.

5. A computer implemented method of displaying Ethiopian alphabet characters comprising:
displaying a root Ethiopian alphabet character at a cursor location on a computer screen in response to a user clicking a keyboard button of an external keyboard;
displaying a popup panel on the computer screen in response to the user clicking the keyboard button, the popup panel displaying Ethiopian alphabet extensions of the root Ethiopian alphabet character and designated keyboard buttons for selecting from among the Ethiopian alphabet extensions, the designated keyboard buttons comprising function keys; and
replacing the root Ethiopian alphabet character with a particular Ethiopian alphabet extension at the cursor location in response to the user clicking a particular function key from among the function keys.
